(19) United States
(12) Patent Application Publication
(10) Pub. No.: US 2019/0080027 A1
(43) Pub. Date: Mar. 14, 2019

(54) Traceable Content Used within Computer Aided Design

(71) Applicant: Onshape Inc., Cambridge, MA (US)

(72) Inventors: Gary Amadon, West Townsend, MA (US); Parapura Rajkumar, Acton, MA (US); Malay Kumar, Acton, MA (US)

(21) Appl. No.: 16/127,643

(22) Filed: Sep. 11, 2018

Related U.S. Application Data
(60) Provisional application No. 62/556,659, filed on Sep. 11, 2017.

(51) Int. Cl. G06F 17/50

(52) U.S. Cl. CPC G06F 17/50; G06F 2217/04; G06F 2217/02

(57) ABSTRACT

Many computer aided design (CAD) models include components that are supplied via third party vendors, also know as suppliers. These suppliers create CAD models of their components, place them in a library organized by logical categories, and then place the library in a cloud enable database infrastructure, which allows access to the supplier's library by other CAD users. As other users create new CAD designs, they will access specific supplier libraries in the cloud and add references to various supplier components within their own CAD design. All the references to any supplier components by any end user is stored in the cloud database infrastructure, allowing the suppliers to query who and how their components are being used in any end users CAD design.

### CROSS-REFERENCE TO RELATED APPLICATIONS

This utility patent application claims priority from U.S. provisional patent application Ser. No. 62/556,659, filed Sep. 11, 2017, titled “Traceable Content Used within Computer Aided Design” and naming inventors Gary Amadon, Parapura Rajkumar, and Malay Kumar.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright 2018, Onshape Inc.

### BACKGROUND

### Field of Technology

This relates to software for computer aided design, and more particularly to computer aided design solutions for component traceability.

### Background

Most CAD designers use content in designs that is supplied via a third party supplier. These components vary widely, for example, a company that designs, manufactures, and sells wood cutting table saws might use an electric motor from a third party supplier in the design of the table saw. The supplier provides a catalog or library of their available motors, the designer uses it in their table saw design and eventually purchases the motor to complete the manufacturing and sale of the table saw.

Typical supplier components include components used in mechanical and machine design, for example, but not limited to:
Fastening components, like bolts, screw, nuts, washers, etc.
Electronic devices, like buttons, switches, indicators, sensors, etc.
Pipe, hose, and tube fittings
Hardware, like hinges, knobs, handles, brackets, etc.
Power transmission components, like gears, bearings, cams, motors, and pumps, air cylinders, etc.

The supplier produces and makes available a library (or libraries) of components to end users (designers), where these components are typically in the form of a CAD model. End users then use these components in their designs. Currently, there is no way for the supplier to know which designers have inquired about or actually used the supplier's CAD components in designs.

### Description of Prior Art

United States Patent Application Publication 2015/0001762 (“METHOD FOR DEPLOYABLE RAPID ON-SITE MANUFACTURING USING 3-D PRINTING IN COMBINATION WITH VACUUM METALLIZATION”, Lacaze et al., Jan. 1, 2015) discloses, in the Abstract, “Deployable On-Site Manufacturing Using 3D Printing is a low cost approach to manufacturing any of thousands of designs at any location. Crowd-sourcing populates a large library of models that can be produced using a small set of standard parts and 3D printed components, as well as highly specialized products. A vacuum metallization process is used in combination with the 3D printer allows printing of antennas designed for a particular frequency, beam form, amplification, size, and weight. These highly specialize products are printed and assembled on-site, as needed. Uses include disaster sites, emergency situations, remote operations, military operations, and homeland security.” This solution addresses third party vendor libraries and the ability to update these libraries as it pertains to on-site 3D printing.

United States Patent Application Publication 2011/0047140 (“COMPUTER SYSTEM AND METHOD FOR PROVIDING REAL-WORLD MARKET-BASED INFORMATION CORRESPONDING WITH A THEORETICAL CAD MODEL AND/OR RFQ/RFP DATA”, Free, Feb. 2, 2011) discloses, in the Abstract, “A market-based search system uses a digital geometric CAD model as a filter against other digital geometric CAD models that have been used or that may be used to produce actual products and that have real-world cost and other transactional data. Specifically, a digital CAD model is used as an index into market-based data. A geometry based search engine can perform a first pass of comparing indexed parameters derived from the CAD model provided in a search query against index data of an indexed CAD assets database. A transaction search engine can then be used to perform a second pass on the results from the geometric based search in order to match any transactional data, process data, or technical attribute data of the CAD model with real-world transactional data and/or process data associated with CAD models discovered by the indexed data search.” This solution assesses geometry of CAD models to determine, amongst other things, cost estimates for manufacturing.

One implementation for multi-user cloud-based 3-D parametric CAD is the Onshape CAD system described in patent application 2016/0246899 (“MULTI-USER CLOUD PARAMETRIC FEATURE-BASED 3D CAD SYSTEM”, Hirsctick et al., Aug. 15, 2016), which is hereby fully incorporated by reference. The Onshape CAD system includes an internet ‘cloud’ based storage mechanism which allows collaboration, sharing and usage access amongst users anywhere in the world.

None of the above provides a multi-user cloud-based CAD system with (1) third-party component libraries, (2) tracking of component use in end designs, and (3) a notification to update designers using components of needed updates, technical issues, or changes in previously used components. What is needed, therefore, is a system that overcomes the above-mentioned limitations and that includes the features enumerated above.

### BRIEF SUMMARY

A system may be implemented within an online, multi-user CAD environment to allow suppliers of CAD components (also referred to as content) to be able to quickly and efficiently determine who has used these components within CAD designs. Via this system, these used third party components can be easily traced by the original supplier.

This system may be implemented within the online, multi-user CAD environment, such as the preferred Onshape CAD solution. All information, including the supplier models and the pertinent information of the end users who have used any supplier content may be stored in a cloud based database. This database is setup to allow fast and efficient retrieval of this information to give suppliers the necessary information to track who is using their content.

The information the supplier has access to includes:
Name of user and/or company
Date used
The number of components used per CAD design per user as well as total number of components used in all designs
If a supplier content was used in a user's design but subsequently deleted
If a supplier content was used in a user's design but subsequently replaced
Properties of the component being used. This would vary based upon the supplier and component, but would most likely map to the technical specifications of the supplier's content. For example, ‘Size’, ‘Part Number’, ‘SKU’, ‘Horse power’, etc.
Most popular sizes per supplier content
Which supplier components are commonly used together with other components

Suppliers may use this information for the following purposes:
Marketing and sales opportunities
   Suppliers can reach out to those end users who have either inquired about using or incorporated their components in their design as marketing and sales leads
Technical updates
   Providing appropriate updates to relevant end users if a supplier component has been updated, is being recalled, or has experienced any other technical change about which the end user should be notified

### BRIEF DESCRIPTION OF THE DRAWINGS

In the drawings, closely related figures and items have the same number but different alphabetic suffixes. Processes, states, statuses, and databases are named for their respective functions.

FIG. 1 illustrates the components of a computer system typically used for CAD design.

FIG. 2 shows the Onshape CAD program interface showing a completed CAD component model design by a supplier.

FIG. 3 shows, within the CAD interface, adding component properties and values to the completed CAD component model of FIG. 2.

FIG. 4 shows the Onshape CAD program connected to Onshape's cloud infrastructure, where supplier libraries reside.

FIG. 5 shows the Onshape CAD program interface with a started assembly design using a supplier library component model, and the interface tools to retrieve and insert that supplier library component model into the design.

FIG. 6 shows the Onshape CAD program displaying a result of a supplier component model usage query.

FIG. 7 shows a usage report.

FIG. 8 is a flowchart of illustrating the system process.

### DETAILED DESCRIPTION, INCLUDING THE PREFERRED EMBODIMENT

In the following detailed description, reference is made to the accompanying drawings which form a part hereof, and in which are shown, by way of illustration, specific embodiments in which may be practiced. It is to be understood that other embodiments may be used, and structural changes may be made without departing from the scope of the present disclosure.

Operation

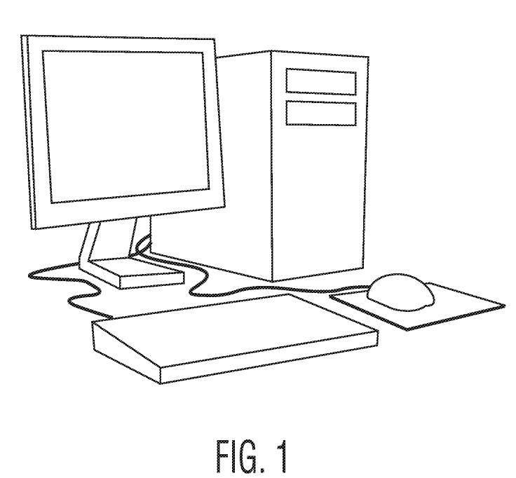

Referring to FIG. 1, a computer system for end user CAD design may include a CPU, a keyboard input device, mouse input device and a display screen. System software can include any modern system operating system such as Apple OS or Microsoft Windows. Software may also includes an internet web browser, such as Google Chrome or Safari, or dedicated CAD software application. The design system may connect to the internet via wired or wireless connection.

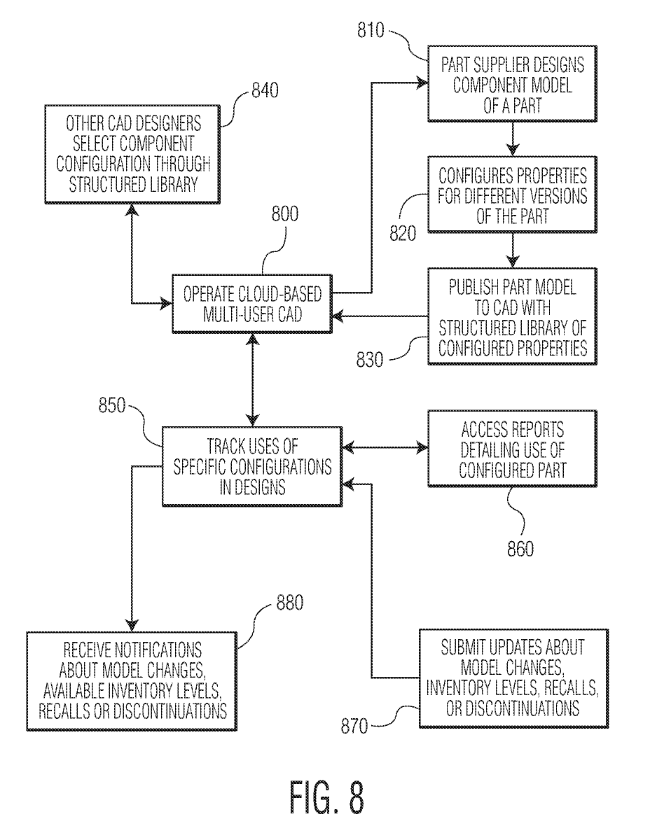

Referring also to FIG. 8, via the internet web browser or dedicated CAD software application, an end user can initiate CAD software accessing or interacting with an online multi-user CAD system such as Onshape CAD 800. The CAD software allows, amongst others, the creation of component models and features, storage of those component models, and access to other component models of other users. Storage of component models may be in files or one or more databases, preferably implemented within a cloud environment for distribution and high performance access from anywhere in the world. Within a cloud environment, one or more servers may provide storage, CAD calculations, and distribute interface software to user devices for operating CAD software.

Once a CAD design is complete, the CAD system may convert the CAD design into manufacturing directives and the design produced as a physical item by a CNC (computer numerical control) machine. Tracking components provided by one supplier and used in other designs provides improved operations for suppliers. Tracked usage patterns and frequencies may allow a supplier to appropriately stock specifically designed parts. Changes, recalls, and discontinuations of specific parts may be pushed to end-use designers to account for changes in advance of real-world impact.

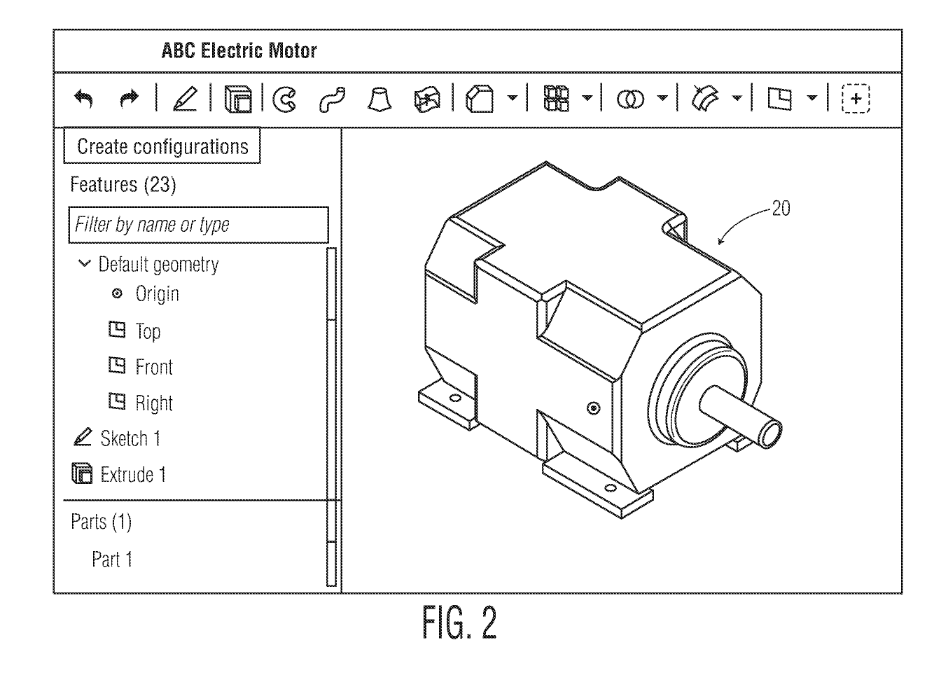

Third parties may supply specific components, and provide libraries of those components for designers to use within designs in the CAD system. Referring also to FIG. 2, an example supplier design engineer is a supplier of electrical motors. Within the CAD software, the supplier design engineer may author 810 a CAD component model 20, such as that of an electrical motor that he is a distributor of. The component is first geometrically modeled using CAD modeling tools. A typical process may include sketching profiles, accurately dimensioning the sketch, and then making 3D parts from the sketch, using typical CAD modeling tools such as Extrude, Revolve, Sweep, and Loft.

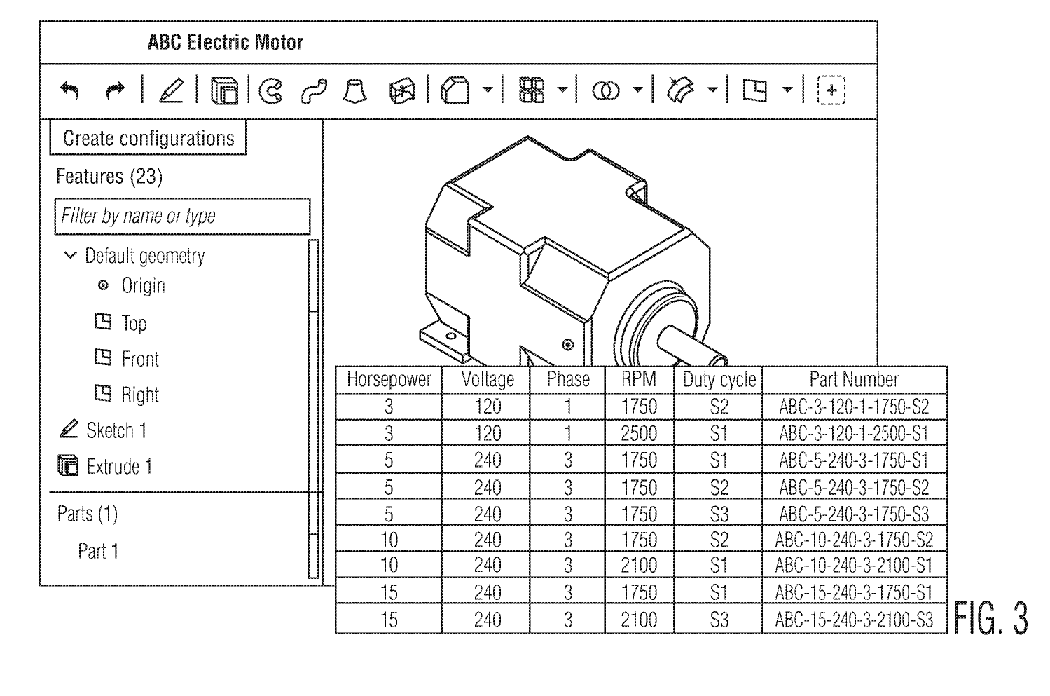

Referring also to FIG. 3, the supplier design engineer adds 820 properties with values for the component, such as such as horsepower, voltage, phase, RPM, duty cycle, part number, for the motor. These properties may be standard properties if the component model is an existing type which has specific categories for properties already defined in the CAD system, or categories may be defined by the supplier design engineer. These properties are pertinent information in which an end user creating designs with the motor would need to know to be use effectively in their own design. The properties may also include information needed for any end user to be be able to purchase said motor from the supplier. Entry and configuration of the properties may be through standard user interface tools within the CAD software interface, such as dialog boxes and selection lists for defining rows and columns, and text entry for individual values. The properties entered may be stored as within a structured library.

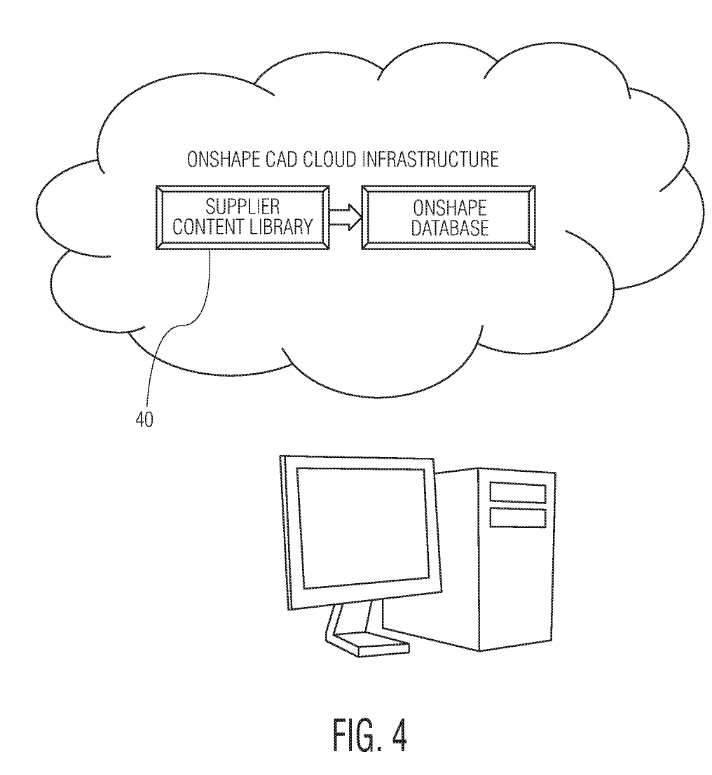

Referring also to FIG. 4, the supplier design engineer publishes 830 the CAD component model. Publishing involves placing the component model into a structured library 40 within the CAD system. A structured library allows the definition of user friendly categories, allowing convenient and fast navigation to model references. Structured libraries may be stored in cloud-based databases or files by the CAD system. By storing supplier structured libraries within a cloud-based infrastructure, they may be accessed by any user of the CAD system.

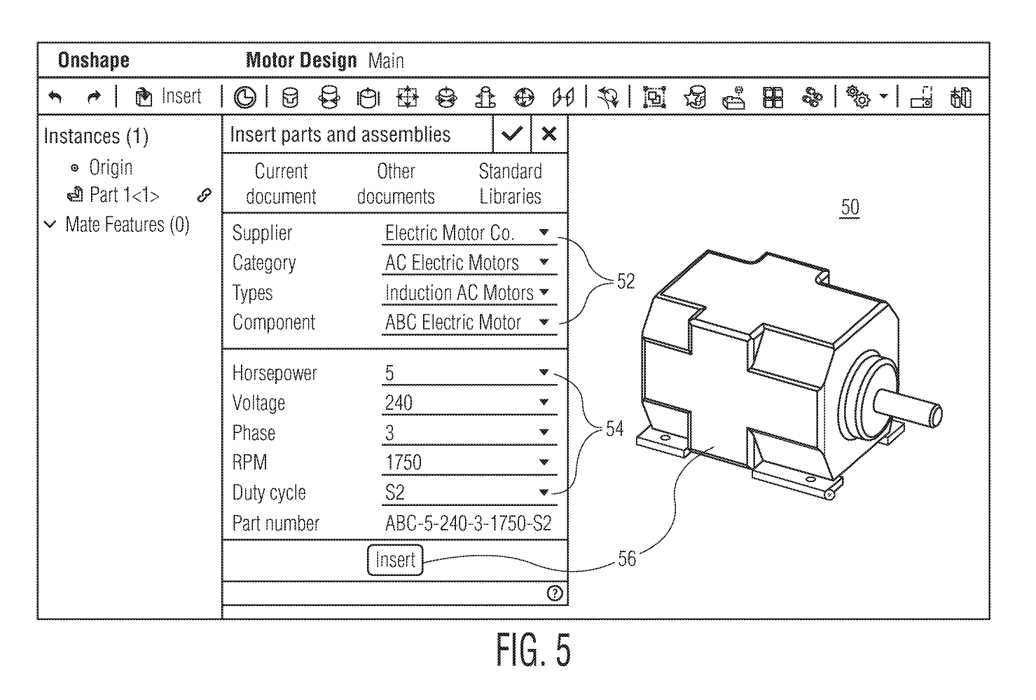

Referring also to FIG. 5, an end user designer creates a CAD design 50. The end user designer may want to include third-party components, such as the electrical motor. Via the CAD software interface, the end designer may browse and select 840 from structured libraries to find a desired third-party component. Upon selecting a specific supplier, fields configured by that supplier in the supplier's structured library may be presented for selection options. Searching may similarly be improved by defining standard categories for suppliers to fill-in, such as category, types, and component. The end designer may navigate and search the various categories to find available desired components, such as electrical motor models 52. The end designer may find the desired model and selects specific property values for insertion into the CAD design 54. The end designer then initiates action to insert the supplier's electrical motor into the design after all desired property values are selected 56. All usage of the motor by the end designer, including the properties and referenced values, may be recorded and stored 850 in the CAD cloud infrastructure, such as through a database table referencing specific component and properties to end user designs.

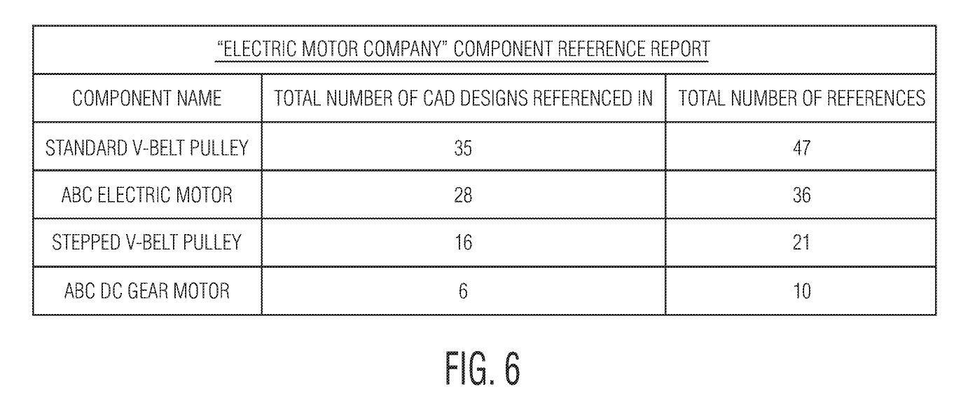

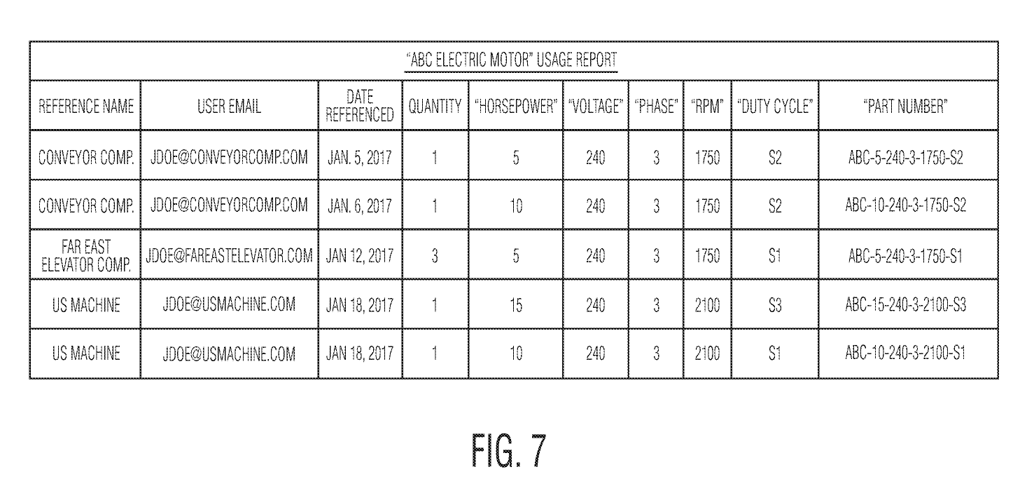

Referring also to FIG. 6, the supplier design engineer may desire to know how many designs their components are being used in as well as the total number of references of all their components. Via online user interface tools through the CAD system, the supplier man query or access 860 reports to retrieve this information. Referring also to FIG. 7, the supplier design engineer may desire to know who and with what properties other end user CAD designers are using a particular component, such as their distributed electrical motor, in designs. Via online user interface tools through the CAD system, the supplier can query or access reports to retrieve all information on how the electrical motor in being used by any end users, anywhere in the world.

Since all data for supplier model content is aggregated and stored in the CAD cloud infrastructure, the data can be retrieved and used in many ways for different purposes. This includes:
Knowing the quantity of actual usage of any given component, thus indicating which supplier products are trending in what direction
Granular analysis of component usage, for example, what the usage of a component is in different geographical regions

Using this information, suppliers may adjust stock levels of specific part models, and ship appropriately to different geographically located distribution centers.

The CAD system may provide a messaging system for the supplier design engineer to contact all end designers using a specific component. This may be done through an automated email, or notification signaled within each end designer CAD account. This tracking and notification allows messaging 870 such as product recalls, discontinuations, or model changes, to reach 880 all end designers using a specific component.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A method for component tracking and notification within multi-user cloud-based computer aided design (CAD), comprising:
authoring a structured library by a providing designer, wherein the structured library has one or more component models;
storing the structured library within a multi-user cloud-based CAD system;
publishing the structured library within the multi-user cloud-based CAD system;
inserting, by an end designer, a component model from the structured library into an assembly design; and
tracking, by the CAD system, all uses of the component model by all end designers who have inserted the component model into one or more designs.

2. The method of claim 1, further comprising notifying, by the CAD system, the tracked end designers of changes or updates to the component model.

3. The method of claim 1, further comprising notifying, by the CAD system, the tracked end designers of recalls of the component model.

4. The method of claim 1, further comprising notifying, by the CAD system, the tracked end designers of discontinuations of the component model.

5. A system for component tracking and notification within multi-user cloud-based computer aided design (CAD), comprising:
a cloud-based CAD server operating software which:
receives a structured library by a providing designer, wherein the structured library has one or more component models;
stores the structured library;
publishes the structured library for access by end designers using CAD design software communicating with the cloud-based CAD server;
solves and stores an assembly design of an end design wherein the assembly design includes an inserted component model from the structured library; and
tracks all uses of the component model by all end designers who have inserted the component model into one or more designs.

6. The system of claim 5, wherein the CAD server operating software which further notifies the tracked end designers of changes or updates to the component model.

7. The system of claim 5, wherein the CAD server operating software which further notifies the tracked end designers of recalls of the component model.

8. The system of claim 5, wherein the CAD server operating software which further notifies the tracked end designers of discontinuations of the component model.
